(19) United States
(12) Patent Application Publication
(10) Pub. No.: US 2025/0140919 A1
(43) Pub. Date: May 1, 2025

(54) BATTERY COMPRISING GEL POLYMER ELECTROLYTE AND METHOD OF MANUFACTURING THE SAME

(71) Applicant: GM GLOBAL TECHNOLOGY OPERATIONS LLC, Detroit, MI (US)

(72) Inventors: Mengyuan CHEN, Madison Heights, MI (US); Bradley R. Frieberg, Farmington Hills, MI (US); Yubin Zhang, Madison Heights, MI (US); Xiaosong Huang, Novi, MI (US)

(21) Appl. No.: 18/495,298

(22) Filed: Oct. 26, 2023

(51) Int. Cl. H01M 10/0565; H01M 10/0525

(52) U.S. Cl. CPC H01M 10/0565; H01M 10/0525; H01M 2220/20; H01M 2300/0025; H01M 2300/0085

(57) ABSTRACT

A battery that cycles lithium ions includes a negative electrode, a positive electrode spaced apart from the negative electrode, and a gel polymer electrolyte disposed between and configured to provide a medium for the conduction of lithium ions between the negative electrode and the positive electrode. The positive electrode includes a high-voltage electroactive material formulated to undergo lithium intercalation and deintercalation. The gel polymer electrolyte includes an aliphatic polyester, a lithium salt, and an ionic liquid. The aliphatic polyester includes a substituted or unsubstituted poly(ethylene carbonate) (PEC). The lithium salt includes lithium sulfonylimide, lithium borate, or a combination thereof. The ionic liquid includes substantially equimolar amounts of a cation and an anion, with the cation including a complex of lithium (Li⁺) and an ethylene glycol dimethyl ether, an imidazole ion, or a combination thereof, and the anion including a sulfinate ion, a borate ion, or a combination thereof.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to electrolytes for batteries that cycle lithium ions, and more particularly to gel polymer electrolytes that comprise a polymer, a lithium salt, and an ionic liquid.

Batteries that cycle lithium ions generally include a positive electrode, a negative electrode spaced apart from the positive electrode, and an ionically conductive electrolyte that provides a medium for the conduction of lithium ions between the positive and negative electrodes during discharge and charge of the batteries. To provide the batteries with high energy densities, high power densities, and high voltage of such batteries, the materials for the negative electrode and the positive electrode should be selected to maximize the electrochemical potential difference between the negative electrode and the positive electrode. To help maintain the cycling stability of the batteries, the electrolyte should be formulated to have a wide electrochemical stability window to avoid undesirable chemical reactions from occurring between the electrolyte and the negative and/or positive electrodes during cycling.

### SUMMARY

A battery that cycles lithium ions, in accordance with one or more embodiments of the present disclosure, comprises a negative electrode, a positive electrode spaced apart from the negative electrode, and a gel polymer electrolyte disposed between and configured to provide a medium for the conduction of lithium ions between the negative electrode and the positive electrode. The positive electrode comprises a high-voltage electroactive material formulated to undergo lithium intercalation and deintercalation. The gel polymer electrolyte comprises an aliphatic polyester, a lithium salt, and an ionic liquid. The aliphatic polyester comprises a substituted or unsubstituted poly(ethylene carbonate) (PEC). The lithium salt comprises lithium sulfonylimide, lithium borate, or a combination thereof. The ionic liquid comprises substantially equimolar amounts of a cation and an anion. The cation comprises a complex of lithium (Li⁺) and an ethylene glycol dimethyl ether, an imidazole ion, or a combination thereof. The anion comprises a sulfinate ion, a borate ion, or a combination thereof.

The substituted or unsubstituted PEC may comprise a PEC homopolymer consisting of repeating substituted or unsubstituted ethylene carbonate monomer units, a PEC-based copolymer primarily comprising repeating substituted or unsubstituted ethylene carbonate monomer units, or a combination thereof.

The aliphatic polyester may further comprise an aliphatic polycarbonate comprising a primary repeating monomer unit having the formula —O—(C═O)—O—R¹—, where R¹ is a substituted or unsubstituted bivalent hydrocarbon group, an aliphatic polylactone comprising a primary repeating monomer unit having the formula —O—(C═O)—R²—, where R² is a substituted or unsubstituted bivalent hydrocarbon group, or a combination thereof.

The aliphatic polyester may further comprise a substituted or unsubstituted poly(propylene carbonate) (PPC), poly(trimethylene carbonate) (PTMC), polycaprolactone (PCL), poly(propiolactone) (PPL), or a combination thereof.

The aliphatic polyester may constitute, by weight, greater than or equal to about 5% and less than or equal to about 30% of the gel polymer electrolyte.

The lithium salt may comprise lithium bis(trifluoromethane)sulfonylimide (LiTFSI), lithium bis(fluorosulfonyl)imide (LiFSI), lithium bis(oxalato)borate (LiBOB), lithium difluoro(oxalato)borate (LiDFOB), or a combination thereof.

The lithium salt may constitute, by weight, greater than or equal to about 40% and less than or equal to about 90% of the gel polymer electrolyte.

The cation of the ionic liquid may comprise a complex of lithium (Li⁺) and triglyme, a complex of lithium (Li⁺) and tetraglyme, or a combination thereof. The anion of the ionic liquid may comprise bis(fluorosulfonyl)imide (FSI), bis(trifluoromethane)sulfonylimide (TFSI), bis(oxalato)borate (BOB), difluorooxalatoborate (DFOB), or a combination thereof.

The ionic liquid may constitute, by weight, greater than or equal to about 5% and less than or equal to about 50% of the gel polymer electrolyte.

The lithium salt may comprise lithium bis(trifluoromethane)sulfonylimide (LiTFSI). The cation of the ionic liquid may comprise a complex of lithium (Li⁺) and triglyme, and the anion of the ionic liquid may comprise bis(trifluoromethane)sulfonylimide (TFSI).

The gel polymer electrolyte may have an oxidation potential of greater than or equal to about 5.5 Volts vs. Li/Li⁺.

The gel polymer electrolyte may have an ionic conductivity of greater than or equal to about 8.5 mS/cm at 60 degrees Celsius (° C.).

The gel polymer electrolyte may further comprise a support comprising a microporous nonwoven material impregnated with and encapsulated in the gel polymer electrolyte.

A battery that cycles lithium ions, in accordance with one or more embodiments of the present disclosure, comprises a negative electrode, a positive electrode spaced apart from the negative electrode, and a gel polymer electrolyte disposed between and configured to provide a medium for the conduction of lithium ions between the negative electrode and the positive electrode. The negative electrode comprises, by weight, greater than or equal to about 97% lithium. The positive electrode comprises a high-voltage electroactive material formulated to undergo lithium intercalation and deintercalation. The gel polymer electrolyte comprises an aliphatic polyester, a lithium salt, and an ionic liquid. The aliphatic polyester comprises a substituted or unsubstituted poly(ethylene carbonate) (PEC). The lithium salt comprises lithium bis(trifluoromethane)sulfonylimide (LiTFSI). The ionic liquid comprises substantially equimolar amounts of a cation and an anion, the cation comprising a complex of lithium (Li⁺) and triglyme, and the anion comprising bis(trifluoromethane)sulfonylimide (TFSI). The lithium salt constitutes, by weight, greater than or equal to about 40% and less than or equal to about 90% of the gel polymer electrolyte.

The substituted or unsubstituted PEC may comprise a PEC homopolymer consisting of repeating substituted or unsubstituted ethylene carbonate monomer units, a PEC-based copolymer primarily comprising repeating substituted or unsubstituted ethylene carbonate monomer units, or a combination thereof.

The aliphatic polyester may further comprise an aliphatic polycarbonate comprising a primary repeating monomer unit having the formula —O—(C═O)—O—R¹—, where R¹ is a substituted or unsubstituted bivalent hydrocarbon group, an aliphatic polylactone comprising a primary repeating monomer unit having the formula —O—(C═O)—R²—, where R² is a substituted or unsubstituted bivalent hydrocarbon group, or a combination thereof.

The aliphatic polyester may constitute, by weight, greater than or equal to about 5% and less than or equal to about 30% of the gel polymer electrolyte.

The cation of the ionic liquid may comprise a complex of lithium (Li⁺) and triglyme, a complex of lithium (Li⁺) and tetraglyme, or a combination thereof. The anion of the ionic liquid may comprise bis(fluorosulfonyl)imide (FSI), bis(trifluoromethane)sulfonylimide (TFSI), bis(oxalato)borate (BOB), difluorooxalatoborate (DFOB), or a combination thereof.

The ionic liquid may constitute, by weight, greater than or equal to about 5% and less than or equal to about 50% of the gel polymer electrolyte.

In a method of manufacturing a battery that cycles lithium ions, an electrolyte precursor is prepared. The electrolyte precursor comprises a solvate ionic liquid and an aliphatic polyester and a lithium salt dissolved in a polar aprotic organic solvent. The solvate ionic liquid comprises lithium bis(trifluoromethane)sulfonylimide (TFSI)-triglyme, lithium bis(trifluoromethane)sulfonylimide (TFSI)-tetraglyme, 1-ethyl-3-methylimidazolium bis[(trifluoromethyl)sulfonyl]imide ([Emim][TFSI]), or a combination thereof. The aliphatic polyester comprises a substituted or unsubstituted poly(ethylene carbonate) (PEC). The lithium salt comprises lithium bis(trifluoromethane)sulfonylimide (LiTFSI). The electrolyte precursor is applied to a substrate that comprises a release film, a positive electrode, or a microporous support structure. Then, the polar aprotic organic solvent is removed from the electrolyte precursor to form a gel polymer electrolyte on the substrate.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic perspective view of an automotive vehicle powered by a battery pack that includes multiple battery modules.

FIG. 2 is a schematic cross-sectional view of a portion of one of the battery modules of FIG. 1, the battery module including multiple electrochemical cells or batteries that cycle lithium ions.

FIG. 3 is a schematic cross-sectional view of a battery that cycles lithium ions, the battery comprising a negative electrode, a positive electrode, and a gel polymer electrolyte sandwiched between the negative electrodes and the positive electrode.

In the drawings, reference numbers may be reused to identify similar and/or identical elements.

### DETAILED DESCRIPTION

The presently disclosed gel polymer electrolytes have a wide electrochemical stability window and can help improve the cycling stability of batteries that cycle lithium ions, particularly batteries that include high-voltage positive electrode materials with working voltages of greater than about 4.3 Volts.

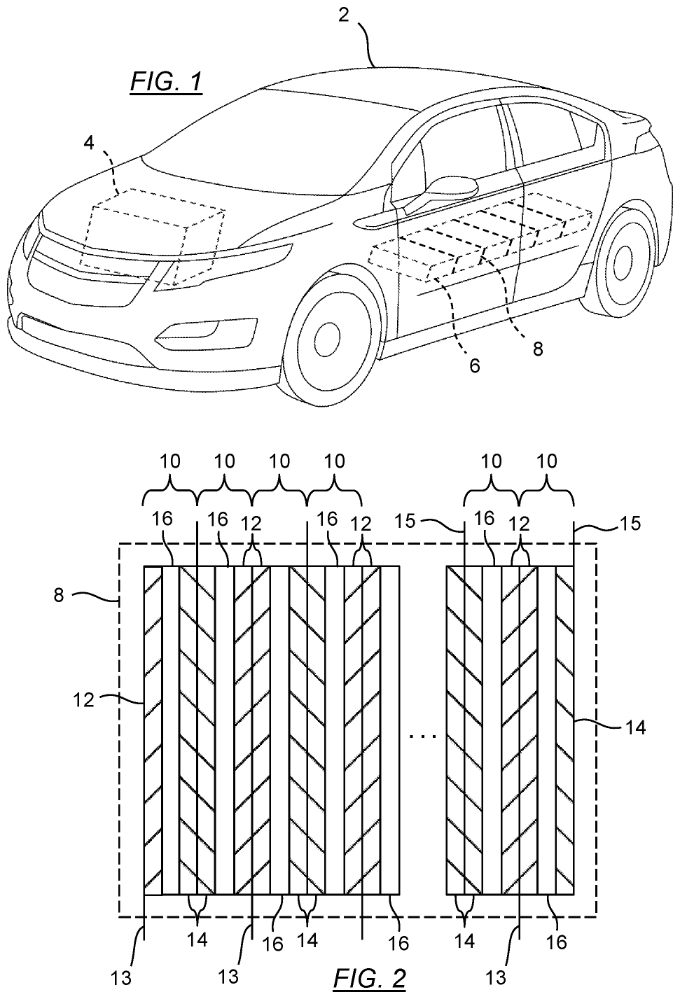

FIG. 1 depicts an automotive vehicle 2 powered by an electric motor 4 that draws electricity from a battery pack 6 including one or more battery modules 8. The battery modules 8 may be electrically coupled together in a series and/or parallel arrangement to meet desired capacity and power requirements of the electric motor 4. The vehicle 2 may be an all-electric vehicle and may be powered exclusively by the electric motor 4, or the vehicle 2 may be a hybrid electric vehicle and may be powered by the electric motor 4 and by an internal combustion engine (not shown).

As shown in FIG. 2, each battery module 8 includes one or more electrochemical cells or batteries 10 that cycle lithium ions. In practice, the batteries 10 in the battery module 8 are oftentimes assembled as a stack of layers, including negative electrode layers 12, negative electrode current collectors 13, positive electrode layers 14, positive electrode current collectors 15, and separator layers 16. Each battery 10 is defined by a negative electrode layer 12 and a positive electrode layer 14, which are spaced apart from each other by a separator layer 16. In practice, the separator layer 16 may be infiltrated with an electrolyte that provides a medium for the conduction of lithium ions between the negative electrode layer 12 and the positive electrode layer 14, or the separator layer 16 itself may function as an electrolyte. The negative electrode layers 12 are disposed on and in electrical communication with the negative electrode current collectors 13 and the positive electrode layers 14 are disposed on an in electrical communication with the positive electrode current collectors 15. As shown in FIG. 2, for efficiency, the layers may be stacked such that some of the negative electrode current collectors 13 and some of the positive electrode current collectors 15 are double sided and respectively include negative electrode layers 12 or positive electrode layers 14 on both sides thereof. In this arrangement, adjacent negative electrode layers 12 and positive electrode layers 14 respectively share a single negative electrode current collector 13 or a positive electrode current collector 15.

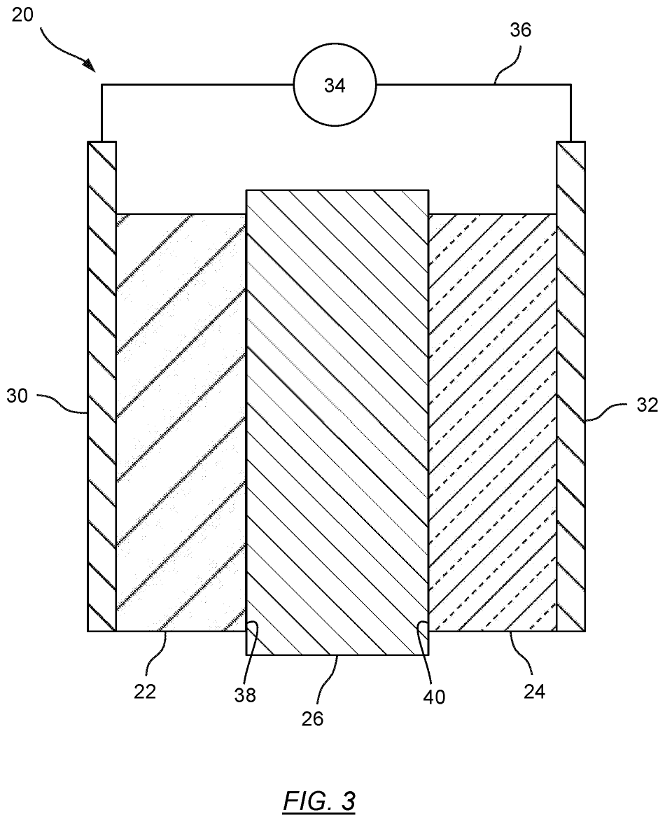

FIG. 3 depicts an electrochemical cell or battery 20 that cycles lithium ions. The battery 20 can generate an electric current during discharge, which may be used to supply power to a load device (e.g., an electric motor 4), and can be charged by being connected to a power source. Like the batteries 10 depicted in FIGS. 1 and 2, in aspects, the battery 20 may be used to supply power to an electric motor 4 of an automotive vehicle 2. Additionally or alternatively, the battery 20 may be used in other transportation applications (e.g., motorcycles, boats, tractors, buses, motorcycles, mobile homes, campers, tanks, and aircraft), and may be used to provide electricity to stationary and/or portable electronic equipment, components, and devices used in a wide variety of other industries and applications, including industrial, residential, and commercial buildings, consumer products, industrial equipment and machinery, agricultural or farm equipment, and heavy machinery, by way of nonlimiting example.

The battery 20 comprises a negative electrode 22, a positive electrode 24, and a gel polymer electrolyte 26 sandwiched between opposing facing surfaces 38, 40 of the negative electrode 22 and the positive electrode 24. The negative electrode 22 is disposed on a negative electrode current collector 30 and the positive electrode 24 is disposed on a positive electrode current collector 32. In practice, the negative electrode current collector 30 and the positive electrode current collector 32 are electrically coupled to a power source or load 34 (e.g., the electric motor 4) via an external circuit 36. The negative electrode 22 and the positive electrode 24 are formulated such that, when the battery 20 is at least partially charged, an electrochemical potential difference is established between the negative electrode 22 and the positive electrode 24. During discharge of the battery 20, the electrochemical potential established between the negative electrode 22 and the positive electrode 24 drives spontaneous reduction and oxidation (redox) reactions within the battery 20 and the release of lithium ions and electrons at the negative electrode 22. The released lithium ions travel from the negative electrode 22 to the positive electrode 24 through the gel polymer electrolyte 26, while the electrons travel from the negative electrode 22 to the positive electrode 24 via the external circuit 36, which generates an electric current. After the negative electrode 22 has been partially or fully depleted of lithium, the battery 20 may be charged by connecting the negative electrode 22 and the positive electrode 24 to the power source 34, which drives nonspontaneous redox reactions within the battery 20 and the release of the lithium ions and the electrons from the positive electrode 24. The repeated discharge and charge of the battery 20 may be referred to herein as “cycling,” with a full charge event followed by a full discharge event being considered a full cycle.

The negative electrode 22 is formulated to store and release lithium ions to facilitate charge and discharge, respectively, of the battery 20. The negative electrode 22 may be in the form of a continuous layer of material disposed on a major surface of the negative electrode current collector 30.

In embodiments, the negative electrode 22 may comprise an electrochemically active (electroactive) material (electroactive negative electrode material) that can store and release lithium ions by undergoing a reversible redox reaction with lithium during charge and discharge of the battery 20. Examples of electroactive negative electrode materials include lithium, lithium-based materials, lithium alloys (e.g., alloys of lithium and silicon, aluminum, indium, tin, or a combination thereof), carbon-based materials (e.g., graphite, activated carbon, carbon black, hard carbon, soft carbon, and/or graphene), silicon, silicon-based materials (e.g., silicon oxide, alloys if silicon and tin, iron, aluminum, cobalt, or a combination thereof and/or composites of silicon and/or silicon oxide and carbon), tin oxide, aluminum, indium, zinc, germanium, silicon oxide, lithium silicon oxide, lithium silicide, titanium oxide, lithium titanate, and combinations thereof. The electroactive material of the negative electrode 22 may constitute, by weight, greater than or equal to about 50%, optionally greater than or equal to about 60%, or optionally greater than or equal to about 70% and less than or equal to about 95%, optionally less than or equal to about 90%, or optionally less than or equal to about 80% of the negative electrode 22.

In embodiments where the negative electrode 22 comprises an electroactive negative electrode material other than lithium, the negative electrode 22 may be in the form of a particulate material, and particles of the electroactive material of the negative electrode 22 may be intermingled with a polymer binder and optionally an electrically conductive material. The polymer binder may provide the negative electrode 22 with structural integrity. Examples of polymer binders include polyvinylidene fluoride (PVDF), polytetrafluoroethylene (PTFE), ethylene propylene diene monomer (EPDM) rubber, styrene butadiene rubber (SBR), carboxymethyl cellulose (CMC), nitrile butadiene rubber (NBR), styrene-butadiene rubber (SBR), styrene ethylene butylene styrene copolymer (SEBS), polyacrylates, alginates, polyacrylic acid, and combinations thereof. The electrically conductive material may provide the negative electrode 22 with good electrical conductivity. Examples of electrically conductive materials include carbon-based materials, metals (e.g., nickel), and/or electrically conductive polymers. Examples of electrically conductive carbon-based materials include carbon black (CB) (e.g., acetylene black), graphite, graphene (e.g., graphene nanoplatelets, GNP), graphene oxide, carbon nanotubes (CNT), and/or carbon fibers (e.g., carbon nanofibers). Examples of electrically conductive polymers include polyaniline, polythiophene, polyacetylene, and/or polypyrrole. In aspects, the negative electrode 22 may comprise an electrically conductive material comprising carbon black.

In embodiments, the negative electrode 22 may consist essentially of or consist of lithium and the negative electrode 22 may be in the form of a nonporous metal film or foil, such as a lithium metal film or lithium metal foil. In such case, the negative electrode 22 may comprise, by weight, greater than 97% lithium, or optionally greater than 99% lithium and may be substantially free of elements or compounds that undergo a reversible redox reaction with lithium during operation of the battery 20. In addition, in such case, the negative electrode 22 may be substantially free of the polymer binder and/or of the electrically conductive material.

The positive electrode 24 is formulated to store and release lithium ions during discharge and charge of the battery 20. The positive electrode 24 may be in the form of a continuous porous layer disposed on the major surface of the positive electrode current collector 32. The positive electrode 24 comprises an electrochemically active (electroactive) material (electroactive positive electrode material), a polymer binder, and optionally an electrically conductive material. In aspects, the electroactive material of the positive electrode 24 may be a particulate material and particles of the electroactive material of the positive electrode 24 may be intermingled with the polymer binder and the optional electrically conductive material.

The electroactive material of the positive electrode 24 can store and release lithium ions by undergoing a reversible redox reaction with lithium at a higher electrochemical potential than the electrochemically active material of the negative electrode 22 such that an electrochemical potential difference exists between the negative electrode 22 and the positive electrode 24. The electroactive material of the positive electrode 24 may comprise a material that can undergo lithium intercalation and deintercalation or a material that can undergo a conversion reaction with lithium. In aspects where the electroactive material of the positive electrode 24 comprises an intercalation host material that can undergo the reversible insertion or intercalation of lithium ions, the electroactive material of the positive electrode 24 may comprise a lithium transition metal oxide. For example, the electroactive material of the positive electrode 24 may comprise a layered lithium transition metal oxide represented by the formula LiMeO₂, an olivine-type lithium transition metal oxide represented by the formula LiMePO₄, a monoclinic-type lithium transition metal oxide represented by the formula Li₃Me₂(PO₄)₃, a spinel-type lithium transition metal oxide represented by the formula LiMe₂O₄, a tavorite represented by one or both of the following formulas LiMeSO₄F or LiMePO₄F, or a combination thereof, where Me is a transition metal (e.g., Co, Ni, Mn, Fe, Al, V, or a combination thereof). In aspects where the electroactive material of the positive electrode 24 comprises a conversion material, the electroactive material of the positive electrode 24 may comprise sulfur, selenium, tellurium, iodine, a halide (e.g., a fluoride or chloride), sulfide, selenide, telluride, iodide, phosphide, nitride, oxide, oxysulfide, oxyfluoride, sulfur-fluoride, sulfur-oxyfluoride, or a lithium and/or metal compound thereof (e.g., a compound of iron, manganese, nickel, copper, and/or cobalt). The electroactive material of the positive electrode 24 may constitute, by weight, greater than or equal to about 50%, optionally greater than or equal to about 60%, or optionally greater than or equal to about 70% and less than or equal to about 95%, optionally less than or equal to about 90%, or optionally less than or equal to about 80% of the positive electrode 24.

In aspects, the electroactive material of the positive electrode 24 may comprise a high-voltage electroactive material having a working voltage of greater than about 4.3 Volts (V), optionally greater than about 4.5 V, or optionally greater than about 4.7 V vs. Li/Li⁺. In aspects, the high-voltage electroactive material of the positive electrode 24 may have a charge cutoff voltage of greater than or equal to about 5 V vs. Li/Li⁺. Examples of high-voltage electroactive positive electrode materials include nickel-rich layered oxides (LiNi₁₋ₓMₓO₂, where M=Co, Mn and/or Al), lithium-rich layered oxides (Li₁₊ₓM₁₋ₓO₂, where M=Mn, Ni, and/or Co), spinel oxides (LiMn₂₋ₓMO₄, where M=Ni, Co, and/or Mn), and polyanionic compounds. Examples of high-voltage nickel-rich layered oxides include LiNiO₂, LiNi₁₋ₓMₓO₂, and Li[Ni_{1-x-y}CoₓMn_{y}]O₂. Examples of lithium-rich layered oxides include (xLi₂MnO₃·(1−x)LiMO₂, where M=Ni, Co, and/or Mn). An example of a high-voltage spinel oxides includes LiNi_{0.5}Mn_{1.5}O₄. Examples of high-voltage polyanionic compounds include phosphates, silicates, sulfates, and combinations thereof.

The polymer binder is electrochemically inactive and may be included in the positive electrode 24 to provide the positive electrode 24 with structural integrity and/or to help the positive electrode 24 adhere to the major surface of the positive electrode current collector 32. Examples of polymer binders include polyvinylidene fluoride (PVdF), polytetrafluoroethylene (PTFE), ethylene propylene diene monomer (EPDM) rubber, styrene butadiene rubber (SBR), carboxymethyl cellulose (CMC), nitrile butadiene rubber (NBR), styrene-butadiene rubber (SBR), styrene ethylene butylene styrene copolymer (SEBS), polyacrylates, alginates, polyacrylic acid, and combinations thereof. The polymer binder may constitute, by weight, greater than or equal to about 1%, or optionally greater than or equal to about 5%, and less than or equal to about 10% of the positive electrode 24.

The optional electrically conductive material is electrochemically inactive and may be included in the positive electrode 24 to provide the positive electrode 24 with sufficient electrical conductivity to support the percolation of electrons therethrough. Examples of electrically conductive materials include carbon-based materials, metals (e.g., nickel), and/or electrically conductive polymers. Examples of electrically conductive carbon-based materials include carbon black (CB) (e.g., acetylene black), graphite, graphene (e.g., graphene nanoplatelets, GNP), graphene oxide, carbon nanotubes (CNT), and/or carbon fibers (e.g., carbon nanofibers). Examples of electrically conductive polymers include polyaniline, polythiophene, polyacetylene, and/or polypyrrole. When included in the positive electrode 24, the optional electrically conductive material may constitute, by weight, greater than 0%, optionally greater than or equal to about 1%, or optionally greater than or equal to about 5% and less than or equal to about 10% of the positive electrode 24.

The gel polymer electrolyte 26 is disposed between the negative electrode 22 and the positive electrode 24 and is configured to provide a medium for the conduction of lithium ions between the negative electrode 22 and the positive electrode 24. The gel polymer electrolyte 26 physically separates and electrically isolates the negative electrode 22 and the positive electrode 24 from each other while permitting lithium ions to pass therethrough. The gel polymer electrolyte 26 may be sandwiched between the negative electrode 22 and the positive electrode 24 and may be in direct physical contact with the opposing facing surfaces 38, 40 of the negative electrode 22 and the positive electrode 24. The gel polymer electrolyte 26 may have a thickness of greater than or equal to about 5 micrometers (μm), optionally greater than or equal to about 10 μm, or optionally greater than or equal to about 20 μm and less than or equal to about 500 μm, optionally less than or equal to about 200 μm, or optionally less than or equal to about 50 μm.

The gel polymer electrolyte 26 comprises an aliphatic polyester, a lithium salt, an ionic liquid, and optionally a support structure.

The aliphatic polyester is formulated to provide the gel polymer electrolyte 26 with flexibility and the ability to establish robust interfacial contact with the facing surface 38 of the negative electrode 22 and with the facing surface 40 of the positive electrode 24. In addition, the aliphatic polyester is formulated to provide the gel polymer electrolyte 26 with a relatively wide electrochemical stability window. For example, the aliphatic polyester may provide the gel polymer electrolyte 26 with a relatively high oxidation potential, as compared to that of poly(ethylene oxide), so that the gel polymer electrolyte 26 thus can be positioned in direct physical contact with the facing surface 40 of the positive electrode 24 without being oxidized, even when the positive electrode 24 is operating at high voltage, e.g., at a voltage of greater than about 5 V. The aliphatic polyester may provide the gel polymer electrolyte 26 with an oxidation potential of greater than about 5 V, optionally greater than about 5.5 V, optionally greater than about 5.6 V, or optionally greater than about 5.7 V vs. Li/Li⁺. The aliphatic polyester may provide the gel polymer electrolyte 26 with a reduction potential of less than 0 V vs. Li/Li⁺. Furthermore, the aliphatic polyester is formulated to provide the gel polymer electrolyte 26 with high ionic conductivity. For example, the aliphatic polyester may provide the gel polymer electrolyte 26 with an ionic conductivity of greater than or equal to about 6 millisiemens per centimeter (mS/cm), optionally greater than or equal to about 7 mS/cm, optionally greater than or equal to about 8 mS/cm, or optionally greater than or equal to about 8.5 mS/cm at 60 degrees Celsius (° C.).

The aliphatic polyester may comprise an aliphatic polycarbonate, an aliphatic polylactone, or a combination thereof. Polycarbonates are polymers with carbonate groups (—O—(C═O)—O—) in their main chain. Polylactones are polymers with ester groups (—C(═O)—O—) in their main chain.

For example, the aliphatic polyester may comprise an aliphatic polycarbonate comprising repeating monomer units having the formula —O—(C═O)—O—R¹—, where R¹ is a substituted or unsubstituted bivalent hydrocarbon group, with the following structure (1):

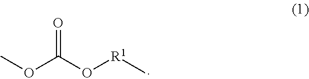

Additionally or alternatively, the aliphatic polyester may comprise an aliphatic polylactone comprising repeating monomer units having the formula —O—(C═O)—R²—, where R² is a substituted or unsubstituted bivalent hydrocarbon group, with the following structure (2):

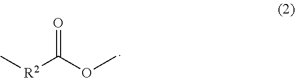

Examples of bivalent hydrocarbon groups (i.e., R¹ and R²) include bivalent acyclic hydrocarbon groups (alkylene groups), bivalent cyclic hydrocarbon groups (arylene groups), bivalent alicyclic hydrocarbon groups, and combinations thereof. Examples of alkylene groups include C₂-C₂₀ straight-chain or branched chain saturated aliphatic groups, e.g., methylene (—CH₂—), ethylene (—CH₂—CH₂—), trimethylene (—CH₂—CH₂—CH₂—), tetramethylene, pentamethylene, hexamethylene, heptamethylene, octamethylene, nonamethylene, decamethylene, dodecamethylene, ethylethylene, 1,2-dimethylethylene, 1,1-dimethylethylene, propylethylene, 1-ethyl-2-methylethylene, butylethylene, pentylethylene, hexylethyleneandoctylethylene, and combinations thereof. Examples of alkylene groups include C₂-C₂₀ straight-chain or branched chain unsaturated aliphatic groups, e.g., alkenylene groups, such as vinylene (—HC═CH—), propenylene (—H₂C═C═CH—), propylene (—CH(CH₃)CH₂—), and combinations thereof. Examples of arylene groups include styrene, benzylethylene, phenylene group (—C₆H₄—), 4,4′-diphenylene, 4,4′-bisphenylene-2,2-propane, 1,8-naphthylene, and combinations thereof. Examples of bivalent alicyclic groups include 1,2-cyclopentylene, 1,3-cyclopentylene, 1,2-cyclohexylene, 1,3-cyclohexylene, 1,4-cyclohexylene, 1,3-cyclohexanedimethylene, 1,4-cyclohexanedimethylene, cyclohexylethylene, and combinations thereof.

The aliphatic polyester may be a homopolymer or a copolymer. For example, the aliphatic polyester may comprise a substituted or unsubstituted aliphatic polycarbonate homopolymer, a substituted or unsubstituted aliphatic polylactone homopolymer, or a combination thereof. In embodiments where the aliphatic polyester comprises a copolymer, the aliphatic polyester may comprise a substituted or unsubstituted polycarbonate-based copolymer, a substituted or unsubstituted polylactone-based copolymer, or a combination thereof. In a polycarbonate-based copolymer, the primary repeating unit in the copolymer chain is a monomer having the formula —O—(C═O)—O—R¹—. In a polylactone-based copolymer, the primary repeating unit in the copolymer chain is a monomer having the formula —O—(C═O)—R²—.

In embodiments, the aliphatic polyester may comprise a poly(ethylene carbonate) (PEC) homopolymer consisting of repeating substituted or unsubstituted ethylene carbonate monomer units (—O—(C═O)—O—CH₂—CH₂—) and/or a PEC-based copolymer primarily comprising repeating substituted or unsubstituted ethylene carbonate monomer units, as well as other repeating monomer units. In embodiments, the aliphatic polyester may comprise a poly(propylene carbonate) (PPC) homopolymer consisting of repeating substituted or unsubstituted propylene carbonate monomer units (—O—(C═O)—O—CH(CH₃)CH₂—) and/or a PPC-based copolymer primarily comprising repeating substituted or unsubstituted propylene carbonate monomer units, as well as other repeating monomer units. In embodiments, the aliphatic polyester may comprise a poly(trimethylene carbonate) (PTMC) homopolymer consisting of repeating substituted or unsubstituted trimethylene carbonate monomer units and/or a PTMC-based copolymer primarily comprising repeating substituted or unsubstituted trimethylene carbonate monomer units, as well as other repeating monomer units. In embodiments, the aliphatic polyester may comprise a polycaprolactone (PCL) homopolymer consisting of repeating substituted or unsubstituted caprolactone monomer units (—O—(C═O)—C₆H₁₀—) and/or a PCL-based copolymer primarily comprising repeating substituted or unsubstituted caprolactone monomer units, as well as other repeating monomer units. In embodiments, the aliphatic polyester may comprise a substituted or unsubstituted poly(propiolactone) (PPL) homopolymer and/or a substituted or unsubstituted PPL-based copolymer. In embodiments, the aliphatic polyester may comprise a substituted or unsubstituted homopolymer or copolymer of PEC, PPC, PTMC, PCL, PPL, or a combination thereof.

When a polymer, copolymer, monomer, or bivalent hydrocarbon group (i.e., R¹ and R²) is referred to as being substituted, this means that one or more hydrogen atoms thereof is substituted or replaced with another atom or a group of atoms referred to as a substituent. Examples of substituents include halogens (e.g., —F, —Cl, —Br, and −I) and straight-chain or branched chain acyclic or cyclic univalent hydrocarbon groups, e.g., C₁-C₁₀ straight-chain or branched chain alkyl groups (—CₙH₂ₙ₊₁), alkenyl groups (—CₙH₂ₙ₋₁, where n is ≥2), aryl groups, alkoxy groups, aryloxy groups, carboxyl groups, acyloxyl groups, and combinations thereof. Examples of straight-chain C₁-C₁₀ alkyl groups include methyl groups (—CH₃), ethyl groups (—CH₂CH₃), propyl groups (—CH₂CH₂CH₃), and butyl groups (—CH₂CH₂CH₂CH₃). Examples of branched-chain C₁-C₁₀ alkyl groups include isopropyl groups (—CH(CH₃)₂), isobutyl groups (—CH₂—CH(CH₃)₂), sec-butyl groups (—(CH₃)CH—CH₂—CH₃), tert-butyl groups (—C(CH₃)₃), isopentyl groups (—(CH₂)₂—CH(CH₃)₂), and tert-pentyl groups (—(CH₃)₂C—CH₂—CH₃). Alkenyl groups are aliphatic hydrocarbon groups with at least one carbon-carbon double bond (C═C) and are formed when a hydrogen atom is removed from an alkene group. Example alkenyl groups include vinyl groups (—CH═CH₂), allyl groups (—CH₂—HC═CH₂), propenyl groups (—CH═CHCH₃), isopropenyl (—(CH₃)C═CH₂), ethylidene groups (═CH—CH₃), isopropylidene groups (═C(CH₃)₂). Examples of aryl groups include phenyl groups (—C₆H₅), benzyl groups (—CH₂—C₆H₅), benzylidene groups (═CH—C₆H₅), styryl groups (—CH═CH—C₆H₅), phenethyl groups (—CH₂—CH₂—C₆H₅), cinnamyl groups (—CH₂—CH═CH—C₆H₅), benzhydryl groups (—CH(C₆H₅)₂), An alkoxy group is an alkyl group singularly bonded to oxygen (—O—X, where X is an alkyl group). An aryloxy group is an aryl group singularly bonded to oxygen (—O—Y, where Y is an aryl group). Examples of alkoxy groups include methoxy groups (—OCH₃) and ethoxy groups (—OCH₂CH₃). Examples of aryloxy groups include phenoxy groups (—OC₆H₅). Carboxyl groups are organic functional groups consisting of a carbon atom doubled bonded to an oxygen atom and single bonded to a hydroxyl group (—C(═O)OH). Acyloxyl groups are represented by the formula —O—(C═O)—X, where X is an alkyl group.

The aliphatic polyester may constitute, by weight, greater than or equal to about 5%, optionally greater than or equal to about 10%, and less than or equal to about 30%, or optionally less than or equal to about 20% of the gel polymer electrolyte 26.

The lithium salt is formulated to provide the gel polymer electrolyte 26 with good ionic conductivity, for example, by generating lithium ion transport channels therethrough. The lithium salt may comprise a lithium sulfonylimide, a lithium borate, or a combination thereof. Examples of lithium sulfonylimide salts include lithium bis(trifluoromethane)sulfonylimide (LiN(CF₃SO₂)₂) (LiTFSI), lithium bis(fluorosulfonyl)imide (LiN(FSO₂)₂) (LiFSI), and combinations thereof. Examples of lithium borate salts include lithium bis(oxalato)borate (LiB(C₂O₄)₂) (LiBOB), lithium difluoro(oxalato)borate (LiBF₂(C₂O₄)) (LiDFOB), and combinations thereof. In aspects, the lithium salt may comprise LiTFSI. The lithium salt may be present in the gel polymer electrolyte 26 at a concentration of greater than or equal to about 3 moles per liter (mol/L), optionally greater than or equal to about 4 mol/L, or optionally greater than or equal to about 5 mol/L and less than or equal to about 10 mol/L, optionally less than or equal to about 8 mol/L, or optionally less than or equal to about 6 mol/L. In aspects, the lithium salt may be present in the gel polymer electrolyte 26 at a concentration of about 5.5 mol/L. The lithium salt may constitute, by weight, greater than or equal to about 40%, optionally greater than or equal to about 50%, or optionally greater than or equal to about 60%, and less than or equal to about 90%, optionally less than or equal to about 80%, or optionally less than or equal to about 70% of the gel polymer electrolyte 26. The relatively high lithium salt concentration in the gel polymer electrolyte 26 may help provide the gel polymer electrolyte 26 with high oxidative stability.

The ionic liquid infiltrates the aliphatic polyester and is formulated to provide the gel polymer electrolyte 26 with a combination of good thermal stability, oxidative stability, and ionic conductivity. In addition, the ionic liquid is formulated to have excellent chemically compatible with the aliphatic polyester. The ionic liquid may help provide the gel polymer electrolyte 26 with good ionic conductivity, for example, by creating lithium ion transfer pathways or bridges therethrough. The ionic liquid comprises a cation and an anion. In embodiments, the cation and the anion may be present in the ionic liquid in substantially equimolar amounts and may be referred to as a solvate ionic liquid. The cation of the ionic liquid may comprise a complex of lithium (Li⁺) and an ethylene glycol dimethyl ether (a glyme), an imidazole ion, or a combination thereof. Examples of glymes include triethylene glycol dimethyl ether (triglyme) and tetraethylene glycol dimethyl ether (tetraglyme). In aspects, the cation of the ionic liquid may comprise a complex of lithium (Li⁺) and triglyme, a complex of lithium (Li⁺) and tetraglyme, or a combination thereof. Examples of imidazole ions include 1-ethyl-3-methylimidazolium ([Emim]⁺). The anion of the ionic liquid may comprise a sulfinate ion, a borate ion, or a combination thereof. Examples of sulfinate ions include bis(fluorosulfonyl)imide (N(FSO₂)₂⁻) (FSI), bis(trifluoromethane)sulfonylimide (N(CF₃SO₂)₂⁻) (TFSI), and combinations thereof. Examples of borate ions include bis(oxalato)borate (B(C₂O₄)₂⁻) (BOB), difluorooxalatoborate (BF₂(C₂O₄)⁻) (DFOB), and combinations thereof. In aspects, the anion of the ionic liquid comprises bis(trifluoromethane)sulfonylimide.

The ionic liquid may constitute, by weight, greater than or equal to about 5%, optionally greater than or equal to about 10%, or optionally greater than or equal to about 20%, and less than or equal to about 50%, optionally less than or equal to about 40%, or optionally less than or equal to about 30% of the gel polymer electrolyte 26.

The optional support structure may help provide the gel polymer electrolyte 26 with mechanical stability and may comprise a microporous nonwoven material impregnated, infiltrated, and/or encapsulated in the gel polymer electrolyte 26. For example, the support structure may comprise a mat of nonwoven fibers. The fibers may comprise a polymer (e.g., a polyolefin and/or a polyamide), glass, or a combination thereof. For example, the support structure may comprise a mat of nonwoven fibers of polypropylene (PP), polyethylene (PE), and/or polyethyleneterephthalate (PET). The support may have a thickness of greater than or equal to about 5 μm, optionally greater than or equal to about 10 μm, and less than or equal to about 200 μm, optionally less than or equal to about 100 μm, or optionally less than or equal to about 50 μm.

Together, the aliphatic polyester, the lithium salt, the ionic liquid, and the optional support structure may constitute, by weight, greater than or equal to about 90%, optionally greater than or equal to about 95%, or optionally greater than or equal to about 99% of the gel polymer electrolyte 26. In embodiments, the gel polymer electrolyte 26 may be substantially free of an organic solvent, i.e., a nonaqueous aprotic organic solvent. Non-limiting examples of non-aqueous aprotic organic solvents include cyclic carbonates (e.g., ethylene carbonate (EC), propylene carbonate (PC), butylene carbonate (BC), fluoroethylene carbonate (FEC), and vinylene carbonate (VC)); linear carbonates (e.g., dimethyl carbonate (DMC), diethyl carbonate (DEC), ethyl methyl carbonate (EMC)); aliphatic carboxylic esters (e.g., methyl formate, methyl acetate, methyl propionate); lactones (e.g., γ-butyrolactone, γ-valerolactone, and/or δ-valerolactone); nitriles (e.g., succinonitrile, glutaronitrile, and/or adiponitrile); sulfones (e.g., tetramethylene sulfone, ethyl methyl sulfone, vinyl sulfone, phenyl sulfone, 4-fluorophenyl sulfone, benzyl sulfone, and/or sulfolane); aliphatic ethers (e.g., triethylene glycol dimethyl ether, tetraethylene glycol dimethyl ether, 1,3-dimethoxypropane, 1,2-dimethoxyethane, 1-2-diethoxyethane, and/or ethoxymethoxyethane); cyclic ethers (e.g., 1,4-dioxane, tetrahydrofuran, 2-methyltetrahydrofuran), 1,3-dioxolane); phosphates (e.g., triethyl phosphate and/or trimethyl phosphate); and combinations thereof.

The negative and positive electrode current collectors 30, 32 are electrically conductive and provide an electrical connection between the external circuit 36 and their respective negative and positive electrodes 22, 24. In aspects, the negative and positive electrode current collectors 30, 32 may be in the form of nonporous metal foils, perforated metal foils, porous metal meshes, or a combination thereof. The negative electrode current collector 30 may be made of copper, nickel, or alloys thereof, stainless steel, or other appropriate electrically conductive material. The positive electrode current collector 32 may be made of aluminum (AI) or another appropriate electrically conductive material.

### Methods

In a method of manufacturing the battery 20, an electrolyte precursor may be prepared. The electrolyte precursor may comprise a mixture of an ionic liquid and a polymer solution. The ionic liquid may have substantially the same composition as the ionic liquid described above with respect to the gel polymer electrolyte 26. For example, the ionic liquid may comprise a solvate ionic liquid of lithium bis(trifluoromethane)sulfonylimide (TFSI)-triglyme, lithium bis(trifluoromethane)sulfonylimide (TFSI)-tetraglyme, 1-ethyl-3-methylimidazolium bis[(trifluoromethyl)sulfonyl]imide ([Emim][TFSI]), or a combination thereof.

The polymer solution may comprise an aliphatic polyester and optionally a lithium salt dissolved in a polar aprotic organic solvent. The aliphatic polyester may have substantially the same composition as the aliphatic polyester described above with respect to the gel polymer electrolyte 26. Examples of polar aprotic organic solvents include acetonitrile (ACN) and tetrahydrofuran (THF). In embodiments where the polymer solution comprises a lithium salt, the lithium salt may have substantially the same composition as the lithium salt described above with respect to the gel polymer electrolyte 26.

The ionic liquid and the polymer solution may be mixed together such that the resulting electrolyte precursor has a desired lithium salt to aliphatic polyester mass ratio. For example, a mass ratio of the lithium salt to aliphatic polyester (lithium salt:aliphatic polyester) in the electrolyte precursor may be greater than or equal to about 1:1, or optionally greater than or equal to about 2:1 and less than or equal to about 4:1, or optionally less than or equal to about 3:1.

In embodiments, the electrolyte precursor may be cast on a substrate to form an electrolyte precursor layer. Then, the polar aprotic organic solvent may be removed from the electrolyte precursor layer to form the gel polymer electrolyte 26. In embodiments, the substrate may comprise a release film and the gel polymer electrolyte 26 may be removed from the release film and applied to the facing surface 38 of the negative electrode 22 or the facing surface 40 of the positive electrode 24. In embodiments, the substrate may comprise the negative electrode 22 or the positive electrode 24 and the electrolyte precursor may be allowed to penetrate the pores of the negative electrode 22 or the positive electrode 24 prior to removing the polar aprotic organic solvent therefrom.

In embodiments where the gel polymer electrolyte 26 comprises a support structure, the substrate may comprise the support structure and may be immersed in the electrolyte precursor such that the support structure is impregnated, infiltrated, and/or encapsulated in the electrolyte precursor. Then, the polar aprotic organic solvent may be removed from the electrolyte precursor layer to form the gel polymer electrolyte 26 including the support structure.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

The terminology used herein is for the purpose of describing example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended terms “comprises,” “comprising,” “including,” and “having,” are to be understood as non-restrictive terms used to describe and claim various embodiments set forth herein, in certain aspects, the terms may alternatively be understood to instead be a more limiting and restrictive term, such as “consisting of” or “consisting essentially of.” Thus, for any given embodiment reciting compositions, materials, components, elements, ingredients, features, integers, operations, and/or process steps, the present disclosure also specifically includes embodiments consisting of, or consisting essentially of, such recited compositions, materials, components, elements, ingredients, features, integers, operations, and/or process steps. In the case of “consisting of,” the alternative embodiment excludes any additional compositions, materials, components, elements, ingredients, features, integers, operations, and/or process steps, while in the case of “consisting essentially of,” any additional compositions, materials, components, elements, ingredients, features, integers, operations, and/or process steps that materially affect the basic and novel characteristics are excluded from such an embodiment, but any compositions, materials, components, elements, ingredients, features, integers, operations, and/or process steps that do not materially affect the basic and novel characteristics can be included in the embodiment.

Any method steps, processes, and operations described herein are not to be construed as necessarily requiring their performance in the order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer, or section. Terms such as “first,” “second,” and other numerical terms when used herein do not imply a sequence or order unless clearly indicated by the context. Thus, a first step, element, component, region, layer, or section discussed below could be termed a second step, element, component, region, layer, or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s), as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges and encompass minor deviations from the given values and embodiments, having about the value mentioned as well as those having exactly the value mentioned. Other than the working examples provided at the end of the detailed description, all numerical values of parameters (e.g., of quantities or conditions) in this specification are to be understood as being modified in all instances by the term “about” whether or not “about” actually appears before the numerical value. Numerical values of parameters in the appended claims are to be understood as being modified by the term “about” only when such term appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%. In addition, disclosure of ranges includes disclosure of all values and further divided ranges within the entire range, including endpoints and sub-ranges given for the ranges.

As used herein, the terms “composition” and “material” are used interchangeably to refer broadly to a substance containing at least the preferred chemical constituents, elements, or compounds, but which may also comprise additional elements, compounds, or substances, including trace amounts of impurities, unless otherwise indicated. An “X-based” composition or material broadly refers to compositions or materials in which “X” is the single largest constituent of the composition or material on a weight percentage (%) basis. This may include compositions or materials having, by weight, greater than 50% X, as well as those having, by weight, less than 50% X, so long as X is the single largest constituent of the composition or material based upon its overall weight. When a composition or material is referred to as being “substantially free” of a substance, the composition or material may comprise, by weight, less than 5%, optionally less than 3%, optionally less than 1%, or optionally less than 0.1% of the substance.

As used herein, the term “metal” may refer to a pure elemental metal or to an alloy of an elemental metal and one or more other metal or nonmetal elements (referred to as “alloying” elements). The alloying elements may be selected to impart certain desirable properties to the alloy that are not exhibited by the base metal element.

What is claimed is:

1. A battery that cycles lithium ions, the battery comprising:
a negative electrode;
a positive electrode spaced apart from the negative electrode and comprising a high-voltage electroactive material formulated to undergo lithium intercalation and deintercalation; and
a gel polymer electrolyte disposed between and configured to provide a medium for the conduction of lithium ions between the negative electrode and the positive electrode, the gel polymer electrolyte comprising:
an aliphatic polyester comprising a substituted or unsubstituted poly(ethylene carbonate) (PEC),
a lithium salt comprising lithium sulfonylimide, lithium borate, or a combination thereof, and
an ionic liquid comprising substantially equimolar amounts of a cation and an anion, the cation comprising a complex of lithium (Li⁺) and an ethylene glycol dimethyl ether, an imidazole ion, or a combination thereof, and the anion comprising a sulfinate ion, a borate ion, or a combination thereof.

2. The battery of claim 1, wherein the substituted or unsubstituted PEC comprises a PEC homopolymer consisting of repeating substituted or unsubstituted ethylene carbonate monomer units, a PEC-based copolymer primarily comprising repeating substituted or unsubstituted ethylene carbonate monomer units, or a combination thereof.

3. The battery of claim 1, wherein the aliphatic polyester further comprises an aliphatic polycarbonate comprising a primary repeating monomer unit having the formula —O—(C═O)—O—R¹—, where R¹ is a substituted or unsubstituted bivalent hydrocarbon group, an aliphatic polylactone comprising a primary repeating monomer unit having the formula —O—(C═O)—R²—, where R² is a substituted or unsubstituted bivalent hydrocarbon group, or a combination thereof.

4. The battery of claim 1, wherein the aliphatic polyester further comprises a substituted or unsubstituted poly(propylene carbonate) (PPC), poly(trimethylene carbonate) (PTMC), polycaprolactone (PCL), poly(propiolactone) (PPL), or a combination thereof.

5. The battery of claim 1, wherein the aliphatic polyester constitutes, by weight, greater than or equal to about 5% and less than or equal to about 30% of the gel polymer electrolyte.

6. The battery of claim 1, wherein the lithium salt comprises lithium bis(trifluoromethane)sulfonylimide (LiTFSI), lithium bis(fluorosulfonyl)imide (LiFSI), lithium bis(oxalato)borate (LiBOB), lithium difluoro(oxalato)borate (LiDFOB), or a combination thereof.

7. The battery of claim 1, wherein the lithium salt constitutes, by weight, greater than or equal to about 40% and less than or equal to about 90% of the gel polymer electrolyte.

8. The battery of claim 1, wherein the cation of the ionic liquid comprises a complex of lithium (Li⁺) and triglyme, a complex of lithium (Li⁺) and tetraglyme, or a combination thereof, and wherein the anion of the ionic liquid comprises bis(fluorosulfonyl)imide (FSI), bis(trifluoromethane)sulfonylimide (TFSI), bis(oxalato)borate (BOB), difluorooxalatoborate (DFOB), or a combination thereof.

9. The battery of claim 1, wherein the ionic liquid constitutes, by weight, greater than or equal to about 5% and less than or equal to about 50% of the gel polymer electrolyte.

10. The battery of claim 1, wherein the lithium salt comprises lithium bis(trifluoromethane)sulfonylimide (LiTFSI), the cation of the ionic liquid comprises a complex of lithium (Li⁺) and triglyme, and the anion of the ionic liquid comprises bis(trifluoromethane)sulfonylimide (TFSI).

11. The battery of claim 1, wherein the gel polymer electrolyte has an oxidation potential of greater than or equal to about 5.5 Volts vs. Li/Li⁺.

12. The battery of claim 1, wherein the gel polymer electrolyte has an ionic conductivity of greater than or equal to about 8.5 mS/cm at 60 degrees Celsius (° C.).

13. The battery of claim 1, wherein the gel polymer electrolyte further comprises:
a support comprising a microporous nonwoven material impregnated with and encapsulated in the gel polymer electrolyte.

14. A battery that cycles lithium ions, the battery comprising:
a negative electrode comprising, by weight, greater than or equal to about 97% lithium;
a positive electrode spaced apart from the negative electrode and comprising a high-voltage electroactive material formulated to undergo lithium intercalation and deintercalation; and
a gel polymer electrolyte disposed between and configured to provide a medium for the conduction of lithium ions between the negative electrode and the positive electrode, the gel polymer electrolyte comprising:
an aliphatic polyester comprising a substituted or unsubstituted poly(ethylene carbonate) (PEC),
a lithium salt comprising lithium bis(trifluoromethane)sulfonylimide (LiTFSI), and
an ionic liquid comprising substantially equimolar amounts of a cation and an anion, the cation comprising a complex of lithium (Li⁺) and triglyme, and the anion comprising bis(trifluoromethane)sulfonylimide (TFSI),
wherein the lithium salt constitutes, by weight, greater than or equal to about 40% and less than or equal to about 90% of the gel polymer electrolyte.

15. The battery of claim 14, wherein the substituted or unsubstituted PEC comprises a PEC homopolymer consisting of repeating substituted or unsubstituted ethylene carbonate monomer units, a PEC-based copolymer primarily comprising repeating substituted or unsubstituted ethylene carbonate monomer units, or a combination thereof.

16. The battery of claim 14, wherein the aliphatic polyester further comprises an aliphatic polycarbonate comprising a primary repeating monomer unit having the formula —O—(C═O)—O—R¹—, where R¹ is a substituted or unsubstituted bivalent hydrocarbon group, an aliphatic polylactone comprising a primary repeating monomer unit having the formula —O—(C═O)—R²—, where R² is a substituted or unsubstituted bivalent hydrocarbon group, or a combination thereof.

17. The battery of claim 14, wherein the aliphatic polyester constitutes, by weight, greater than or equal to about 5% and less than or equal to about 30% of the gel polymer electrolyte.

18. The battery of claim 14, wherein the cation of the ionic liquid comprises a complex of lithium (Li⁺) and triglyme, a complex of lithium (Li⁺) and tetraglyme, or a combination thereof, and wherein the anion of the ionic liquid comprises bis(fluorosulfonyl)imide (FSI), bis(trifluoromethane)sulfonylimide (TFSI), bis(oxalato)borate (BOB), difluorooxalatoborate (DFOB), or a combination thereof.

19. The battery of claim 14, wherein the ionic liquid constitutes, by weight, greater than or equal to about 5% and less than or equal to about 50% of the gel polymer electrolyte.

20. A method of manufacturing a battery that cycles lithium ions, the method comprising:
preparing an electrolyte precursor comprising a solvate ionic liquid and an aliphatic polyester and a lithium salt dissolved in a polar aprotic organic solvent, the solvate ionic liquid comprising lithium bis(trifluoromethane)sulfonylimide (TFSI)-triglyme, lithium bis(trifluoromethane)sulfonylimide (TFSI)-tetraglyme, 1-ethyl-3-methylimidazolium bis[(trifluoromethyl)sulfonyl]imide ([Emim][TFSI]), or a combination thereof, the aliphatic polyester comprising a substituted or unsubstituted poly(ethylene carbonate) (PEC), and the lithium salt comprising lithium bis(trifluoromethane)sulfonylimide (LiTFSI);
applying the electrolyte precursor to a substrate, the substrate comprising a release film, a positive electrode, or a microporous support structure; and
removing the polar aprotic organic solvent from the electrolyte precursor to form a gel polymer electrolyte on the substrate.
